(19) United States
(12) Patent Application Publication
(10) Pub. No.: US 2018/0347572 A1
(43) Pub. Date: Dec. 6, 2018

(54) VORTEX PUMP

(71) Applicant: AISAN KOGYO KABUSHIKI KAISHA, Obu-shi, Aichi (JP)

(72) Inventors: Atsushi SUGIMOTO, Obu-shi (JP); Eiji NAKAMURA, Obu-shi, Aichi (JP); Nobuhiro KATO, Tokai-shi (JP); Shinya SUZUKI, Nagoya-shi (JP)

(21) Appl. No.: 15/778,084

(22) PCT Filed: Nov. 17, 2016
(86) PCT No.: PCT/JP2016/084133

§ 371 Date: May 22, 2018

(30) Foreign Application Priority Data
Nov. 24, 2015 (JP) 2015-229103

(51) Int. Cl. F04D 23/00; F02M 25/08; F02D 41/00; B60K 15/03

(52) U.S. Cl. CPC F04D 23/008; F02M 25/0854; F02M 2025/0845; B60K 15/03006; F02D 41/0032

(57) ABSTRACT

A vortex pump configured to discharge gas suctioned into the vortex pump to an engine of a vehicle, the pump including: an impeller; and a housing rotatably housing the impeller and including a discharge channel extending from an outer circumferential edge of the impeller along a direction separating away from a rotation axis of the impeller, where the impeller includes: a plurality of blades disposed in an outer circumferential portion of an end surface of the impeller along a rotation direction of the impeller; a plurality of blade grooves, each of which is disposed between adjacent blades; and an outer circumferential wall disposed at the outer circumferential edge for closing the plurality of blade grooves at an outer circumferential side of the impeller, and the housing includes an opposing groove opposing the plurality of the blade grooves and extending along the rotation direction of the impeller.

### TECHNICAL FIELD

The description herein relates to a vortex pump that discharges a suctioned gas to an engine of a vehicle. The vortex pump may also be called a Wesco pump, a cascade pump, or a regenerative pump.

BACKGROUND ART

Japanese Utility Model Application Publication No. 2000-205167 (U) describes a vortex pump provided with an impeller and a housing. The housing rotatably houses the impeller. The housing has a discharge channel extending outward from an outer circumferential end of the impeller arranged therein. The impeller has a plurality of blades and blade grooves arranged between adjacent blades at an outer circumferential end of the impeller.

### SUMMARY

### Technical Problem

In the vortex pump, a vortex (which is also called swirling flow) about a center axis along a rotation direction of the impeller is generated by rotation of the impeller in a fluid inside a space located between the blade grooves of the impeller and the housing. As a result, the fluid is pressurized, and is discharged to outside the vortex pump from a discharge port.

In the vortex pump, when a gas pressurized in the housing is discharged to the discharge channel, a pressure in the space where the discharged gas was present drops. As a result, a phenomenon in which the fluid that was once discharged to the discharge channel flows back into the space between the blade grooves of the impeller and the housing occurs. Especially in a case where the fluid is a gas, a high-pressure gas compresses the gas inside the housing, by which the high-pressure gas is more prone to flowing back.

In the disclosure herein, a technique that suppresses an occurrence of a situation in which a gas flows back from a discharge channel into a housing in a vortex gas pump is provided.

### Solution to Problem

The disclosure herein discloses a vortex pump configured to discharge a suctioned gas to an engine of a vehicle. The vortex pump may comprise an impeller and a housing rotatably housing the impeller. The housing may comprise a discharge channel extending from an outer circumferential edge of the impeller along a direction separating away from a rotation axis of the impeller. The impeller may comprise: a plurality of blades disposed in an outer circumferential portion of an end surface of the impeller along a rotation direction of the impeller; a plurality of blade grooves, each of the plurality of blade grooves being disposed between adjacent blades; and an outer circumferential wall disposed at the outer circumferential edge, the outer circumferential wall closing the plurality of blade grooves at an outer circumferential side of the impeller. The housing may comprise an opposing groove opposing the plurality of the blade grooves and extending along the rotation direction of the impeller.

In the vortex pump used for a gas, the gas is filled in the housing while it is driving. However, for example, in a situation where a high-pressure gas in the discharge channel flows back into the housing, the gas inside the housing is compressed and the high-pressure gas may easily flow back into the housing. For example, in a case of using the pump for a liquid, a volume of the liquid that is to be filled in the housing does not change despite being pressurized, from which the backflow is less likely to occur. Thus, an influence of the backflow from the discharge channel does not have to be considered.

However, the vortex pump used to supply gas to the engine of the vehicle simply needs to supply the gas by an amount to be used in the engine, so a gas amount discharged from the vortex pump is not large. Due to this, when a backflow amount from a discharge channel increases even by a small amount, a ratio of the backflow amount from a discharge port relative to a discharged gas amount becomes high, and pump efficiency is thereby reduced.

In the above vortex pump, the outer circumferential wall is arranged at an outer circumferential edge of the impeller. Due to this, a flow of gas flowing back from the discharge channel extending from the outer circumferential edge of the impeller may be suppressed by the outer circumferential wall. Further, a vortex of the gas in a space formed by the blade grooves of the impeller and the opposing groove of the housing is guided by the outer circumferential wall and swirls in the space smoothly. Due to this, a gas pressure is raised by making the swirling motion of the vortex smooth, and the gas may thereby be discharged to outside the housing from the discharge channel.

The outer circumferential wall may comprise a plurality of outer grooves arranged along a circumferential direction of the impeller, the plurality of outer grooves being recessed toward a radial direction of the impeller. According to this configuration, the gas that had flown into the discharge channel may be suppressed from flowing back to an impeller side by the outer grooves.

An end of the outer circumferential wall in an impeller rotation axis direction may be located at a specific position in the impeller rotation axis direction or closer to an end surface side of the impeller than the specific position in the impeller rotation axis direction. The specific position may be a center of a vortex generated by the respective blade grooves and the opposing groove while the impeller rotates. According to this configuration, the gas flowing toward the outer circumferential direction of the impeller may be guided in a swirling direction of the vortex by the outer circumferential wall.

The housing may comprise an opposing wall opposing the outer circumferential wall along a circumferential direction of the impeller. The opposing wall may comprise a recess portion recessed toward a direction separating away from the impeller. According to this configuration, the gas outside the outer circumferential wall of the impeller may be pressurized by the recess portion while the vortex pump is driving. Due to this, the gas pressurized by the blade grooves of the impeller may be suppressed from flowing out between the outer circumferential wall of the impeller and the opposing wall of the housing. As a result, a situation in which pressurization by the blade grooves is hindered may be avoided. Due to this, a gas amount to be discharged from the pump may be improved.

The recess portion may extend along the circumferential direction of the impeller. According to this configuration, the gas outside the outer circumferential wall of the impeller may be pressurized by the recess portion.

The recess portion may surround an outer circumference of the impeller along the circumferential direction of the impeller. The outer circumferential wall may comprise a projected portion disposed inside of the recess portion. According to this configuration, a passage in the rotation axis direction between the impeller and the housing may be made complex. Due to this, the gas may be suppressed from flowing between the outer circumferential wall of the impeller and the opposing wall of the housing.

### BRIEF DESCRIPTION OF DRAWINGS

FIG. 1 shows a schematic configuration of a fuel supply system of a vehicle of a first embodiment.

FIG. 2 shows a perspective view of a purge pump of the first embodiment.

FIG. 3 shows a cross-sectional view along a III-III cross section of FIG. 2.

FIG. 4 shows a plan view of an impeller of the first embodiment.

FIG. 5 shows a perspective view of the impeller of the first embodiment.

FIG. 6 shows a bottom view of a cover of the first embodiment as seen from below.

FIG. 7 shows an enlarged view of a region AR of FIG. 3.

FIG. 8 shows a simulation result comparing pump efficiency of the impeller of the first embodiment and an impeller of a comparative example.

FIG. 9 shows a perspective view of an impeller of a variant.

FIG. 10 shows a cross-sectional view along the III-III cross section of FIG. 2 of a second embodiment.

FIG. 11 shows a cross-sectional view along the III-III cross section of FIG. 2 of a third embodiment.

FIG. 12 shows a cross-sectional view along the III-III cross section of FIG. 2 of a fourth embodiment.

FIG. 13 shows a cross-sectional view along the III-III cross section of FIG. 2 of a fifth embodiment.

FIG. 14 shows a cross-sectional view along the III-III cross section of FIG. 2 of a sixth embodiment.

FIG. 15 shows a cross-sectional view along the III-III cross section of FIG. 2 of a seventh embodiment.

FIG. 16 shows a side view of an impeller of the seventh embodiment.

FIG. 17 shows a cross-sectional view along the III-III cross section of FIG. 2 of an eighth embodiment.

### DETAILED DESCRIPTION

### First Embodiment

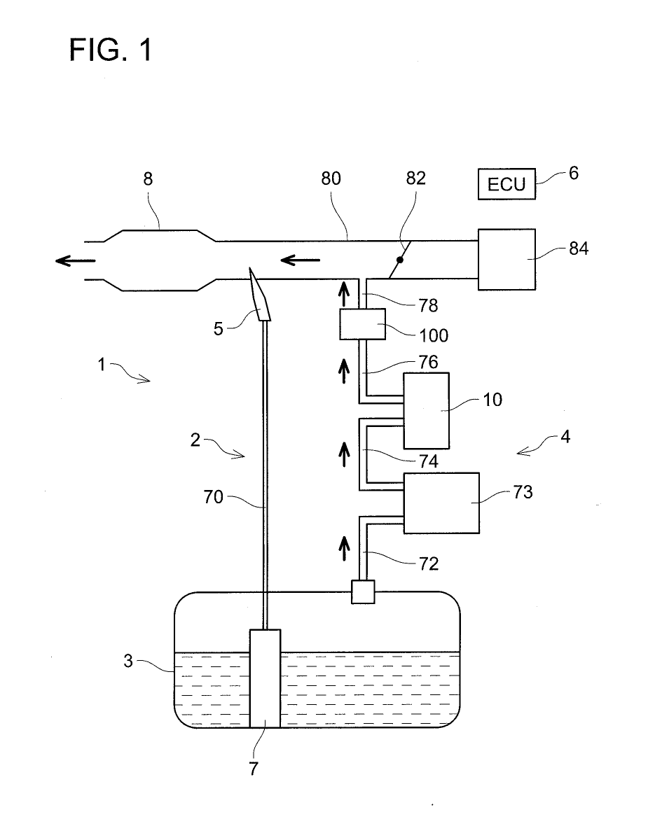

A purge pump 10 of a first embodiment will be described with reference to the drawings. As shown in FIG. 1, the purge pump 10 is mounted in a vehicle, and is arranged in a fuel supply system 1 that supplies fuel stored in a fuel tank 3 to an engine 8. The fuel supply system 1 includes a main supply 2 and a purge supply passage 4 for supplying the fuel from the fuel tank 3 to the engine 8.

The main supply passage 2 includes a fuel pump unit 7, a supply pipe 70, and an injector 5 arranged thereon. The fuel pump unit 7 includes a fuel pump, a pressure regulator, a control circuit, and the like. In the fuel pump unit 7, the control circuit controls the fuel pump according to a signal supplied from an ECU (abbreviation of Engine Control Unit) 6 to be described later. The fuel pump pressurizes and discharges the fuel in the fuel tank 3. The fuel discharged from the fuel pump is regulated by the pressure regulator, and is supplied from the fuel pump unit 7 to the supply pipe 70.

The supply pipe 70 communicates the fuel pump unit 7 and the injector 5. The fuel supplied to the supply pipe 70 flows in the supply pipe 70 to the injector 5. The injector 5 includes a valve of which aperture is controlled by the ECU 6. When this valve is opened, the injector 5 supplies the fuel supplied from the supply pipe 70 to the engine 8.

The purge supply passage 4 is provided with a canister 73, a purge pump 10, a VSV (abbreviation of Vacuum Switching Valve) 100, and communicating pipes 72, 74, 76, 78 communicating them. FIG. 1 shows a flowing direction of the gas in the purge supply passage 4 and the suction pipe 80 by arrows. The canister 73 absorbs vaporized fuel generated in the fuel tank 3. The canister 73 includes a tank port, a purge port, and an open-air port. The tank port is connected to the communicating pipe 72 extending from an upper end of the fuel tank 3. Due to this, the canister 73 is communicated with the communicating pipe 72 extending from the upper end of the fuel tank 3. The canister 73 accommodates an activated charcoal capable of absorbing the fuel. The activated charcoal absorbs the vaporized fuel from gas that enters into the canister 73 from the fuel tank 3 through the communicating pipe 72. The gas that had flown in to the canister 73 passes through the open-air port of the canister 73 after the vaporized fuel has been absorbed, and is discharged to open air. Due to this, the vaporized fuel can be suppressed from being discharged to open air.

The purge port of the canister 73 connects to the purge pump 10 via the communicating pipe 74. Although a detailed structure will be described later, the purge pump 10 is a so-called vortex pump (which may also be called a cascade pump or a Wesco pump) that pressure-feeds gas. The purge pump 10 is controlled by the ECU 6. The purge pump 10 suctions the vaporized fuel absorbed in the canister 73 and pressurizes and discharges the same. During when the purge pump 10 is driving, air is suctioned from the open-air port in the canister 73, and is flown to the purge pump 10 together with the vaporized fuel.

The vaporized fuel discharged from the purge pump 10 passes through the communicating pipe 76, the VSV 100, and the communicating pipe 78, and flows into the suction pipe 80. The VSV 100 is an electromagnetic valve controlled by the ECU 6. The VSV 100 adjusts a vaporized fuel amount supplied from the purge supply passage 4 to the suction pipe 80. The VSV 100 is connected to the suction pipe 80 upstream of the injector 5. The suction pipe 80 is a pipe that supplies air to the engine 8. A throttle valve 82 is arranged on the suction pipe 80 upstream of a position where the VSV 100 is connected to the suction pipe 80. The throttle valve 82 controls an aperture of the suction pipe 80 to adjust the air flowing into the engine 8. The throttle valve 82 is controlled by the ECU 6.

An air cleaner 84 is arranged on the suction pipe 80 upstream of the throttle valve 82. The air cleaner 84 includes a filter that removes foreign particles from the air flowing into the suction pipe 80. In the suction pipe 80, when the throttle valve 82 opens, the air is suctioned from the air cleaner 84 toward the engine 8. The engine 8 internally combusts the air and the fuel from the suction pipe 80 and discharges exhaust after the combustion.

In the purge supply passage 4, the vaporized fuel absorbed in the canister 73 can be supplied to the suction pipe 80 by driving the purge pump 10. In a case where the engine 8 is running, a negative pressure is generated in the suction pipe 80. Due to this, even in a state where the purge pump 10 is at a halt, the vaporized fuel absorbed in the canister 73 is suctioned into the suction pipe 80 by passing through the halted purge pump 10 due to the negative pressure in the suction pipe 80. On the other hand, in cases of terminating idling of the engine 8 upon stopping the vehicle and running by a motor while the engine 8 is halted as in a hybrid vehicle, that is, in other words in a case of controlling an operation of the engine 8 in an ecofriendly mode, a situation arises in which the negative pressure in the suction pipe 80 by the operation of the engine 8 is hardly generated. In such a situation, the purge pump 10 can supply the vaporized fuel absorbed in the canister 73 to the suction pipe 80 by taking over this role from the engine 8. In a variant, the purge pump 10 may be driven to suction and discharge the vaporized fuel even in the situation where the engine 8 is running and the negative pressure is being generated in the suction pipe 80.

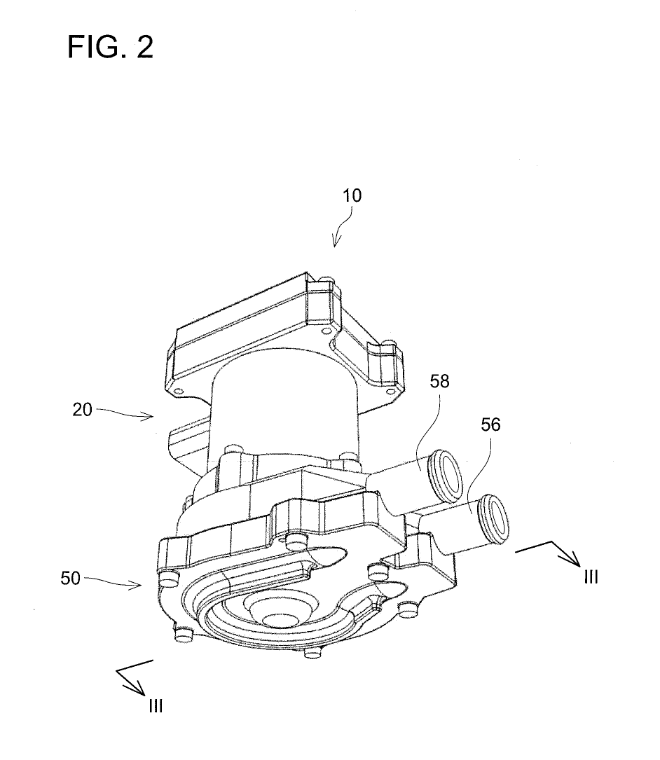

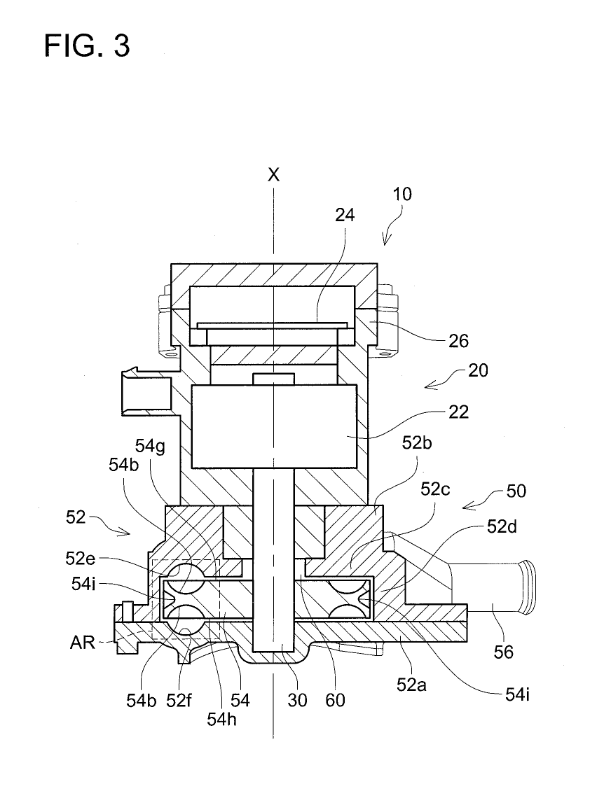

Next, a configuration of the purge pump 10 will be described. FIG. 2 shows a perspective view of the purge pump 10 as seen from a pump unit 50 side. FIG. 3 is a cross sectional view showing a III-III cross section of FIG. 2. Hereinbelow, “up” and “down” will be expressed with an up and down direction of FIG. 3 as a reference, however, the up and down direction of FIG. 3 may not be a direction by which the purge pump 10 is mounted on the vehicle.

The purge pump 10 includes a motor unit 20 and a pump unit 50. The motor unit 20 includes a brushless motor. The motor unit 20 is provided with an upper housing 26, a rotor (not shown), a stator 22, and a control circuit 24. The upper housing 26 accommodates the rotor, the stator 22, and the control circuit 24. The control circuit 24 converts DC power supplied from a battery of the vehicle to three-phase AC power in U phase, V phase, and W phase, and supplies the same to the stator 22. The control circuit 24 supplies the power to the stator 22 according to a signal supplied from the ECU 6. The stator 22 has a cylindrical shape, at a center of which the rotor is arranged. The rotor is arranged rotatable relative to the stator 22. The rotor includes permanent magnets along its circumferential direction, which are magnetized alternately in different directions. The rotor rotates about a shaft 30 by the power being supplied to the stator 22.

The pump unit 50 is arranged below the motor unit 20. The pump unit 50 is driven by the motor unit 20. The pump unit 50 includes a lower housing 52 and an impeller 54. The lower housing 52 is fixed to a lower end of the upper housing 26. The lower housing 52 includes a bottom wall 52a and a cover 52b. The cover 52b includes an upper wall 52c, a circumferential wall 52d, a suction port 56, and a discharge port 58 (see FIG. 2). The upper wall 52c is arranged at the lower end of the upper housing 26. The circumferential wall 52d protrudes from the upper wall 52c downward, and surrounds an outer circumference of a circumferential edge of the upper wall 52c. The bottom wall 52a is arranged at a lower end of the circumferential wall 52d. The bottom wall 52a is fixed to the cover 52b by bolts. The bottom wall 52a closes the lower end of the circumferential wall 52d. A space 60 is defined by the bottom wall 52a and the cover 52b.

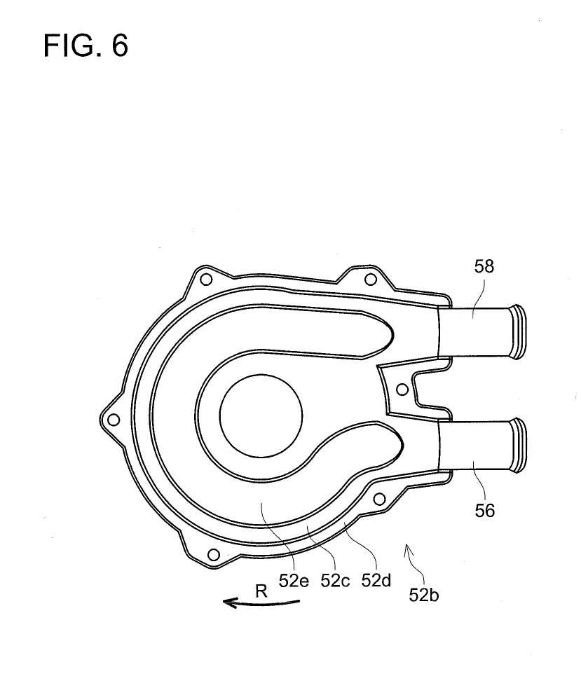

FIG. 6 is a diagram seeing the cover 52b from below. The circumferential wall 52d has the suction port 56 and the discharge port 58 which respectively communicates with the space 60 protruding therefrom. The suction port 56 and the discharge port 58 are arranged parallel to each other and perpendicular to the up and down direction. The suction port 56 communicates with the canister 73 via the communicating pipe 74. The suction port 56 includes a suction channel therein, and introduces the vaporized fuel from the canister 73 into the space 60. The discharge port 58 includes a discharge channel therein, communicates with the suction port 56 in the lower housing 52, and discharges the vaporized fuel suctioned into the space 60 to outside the purge pump 10.

The upper wall 52c includes an opposing groove 52e extending from the suction port 56 to the discharge port 58 along the circumferential wall 52d. The bottom wall 52a similarly includes an opposing groove 52f (see FIG. 3) extending from the suction port 56 to the discharge port 58 along the circumferential wall 52d. When seen along a rotation direction R of the impeller 54, the discharge port 58 and the suction port 56 are separated by the circumferential wall 52d. Due to this, gas can be suppressed from flowing from the high-pressure discharge port 58 to the low-pressure suction port 56.

As shown in FIG. 3, the space 60 accommodates the impeller 54. The impeller 54 has a circular disk-like shape. A thickness of the impeller 54 is somewhat smaller than a gap between the upper wall 52c and the bottom wall 52a of the lower housing 52. The impeller 54 opposes each of the upper wall 52c and the bottom wall 52a with a small gap in between. Further, a small gap is provided between the impeller 54 and the circumferential wall 52d. The impeller 54 includes a fitting hole at its center for fitting the shaft 30. Due to this, the impeller 54 rotates about a rotation axis X accompanying rotation of the shaft 30.

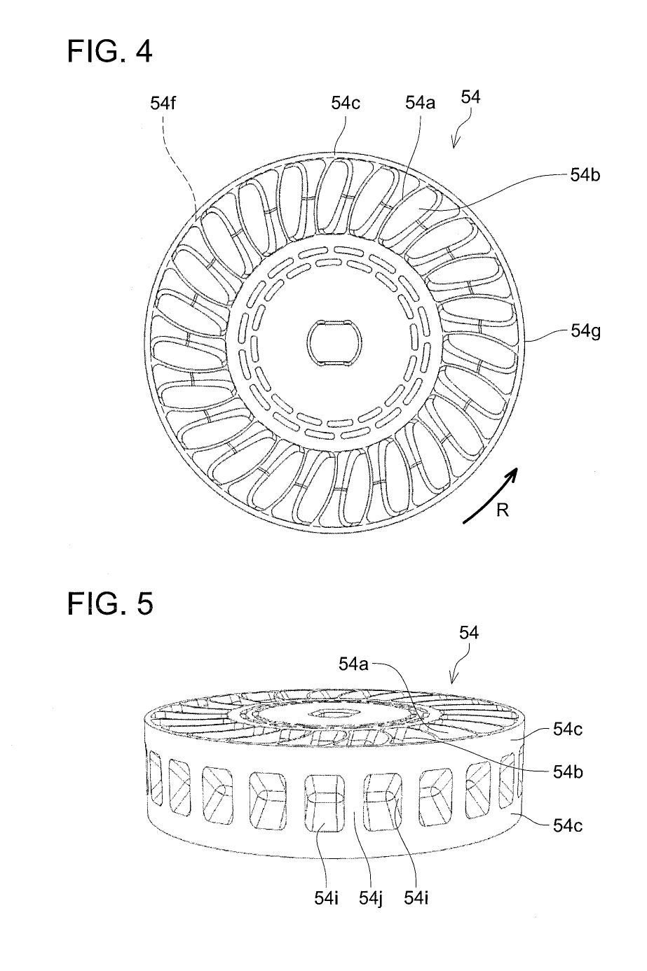

As shown in FIG. 4, the impeller 54 includes a blade groove region 54f, which includes a plurality of blades 54a and a plurality of blade grooves 54b, at an outer circumferential portion of its upper surface 54g. In the drawings, reference signs are given only to one blade 54a and one blade groove 54b. Similarly, the impeller 54 further includes a blade groove region 54f, which includes a plurality of blades 54a and a plurality of blade grooves 54b, at an outer circumferential portion of its lower surface 54h. The upper surface 54g and the lower surface 54h can be termed end surfaces of the impeller 54 in the rotation axis X direction. The blade groove region 54f arranged in the upper surface 54g is arranged opposing the opposing groove 52e. Similarly, the blade groove region 54f arranged in the lower surface 54h is arranged opposing the opposing groove 52f. Each of the blade groove regions 54f surrounds the outer circumference of the impeller 54 in the circumferential direction at an inner side of the outer circumferential wall 54c of the impeller 54. The plurality of blades 54a each has a same shape. The plurality of blades 54a is arranged at an equal interval in the circumferential direction of the impeller 54 in each blade groove region 54f. One blade groove 54b is arranged between two blades 54a that are adjacent in the circumferential direction of the impeller 54. That is, the plurality of blade grooves 54b is arranged at an equal interval in the circumferential direction of the impeller 54 on the inner side of the outer circumferential wall 54c of the impeller 54. In other words, each of the plurality of blade grooves 54b has its end on an outer circumferential side closed by the outer circumferential wall 54c. The plurality of blade grooves 54b has a same shape.

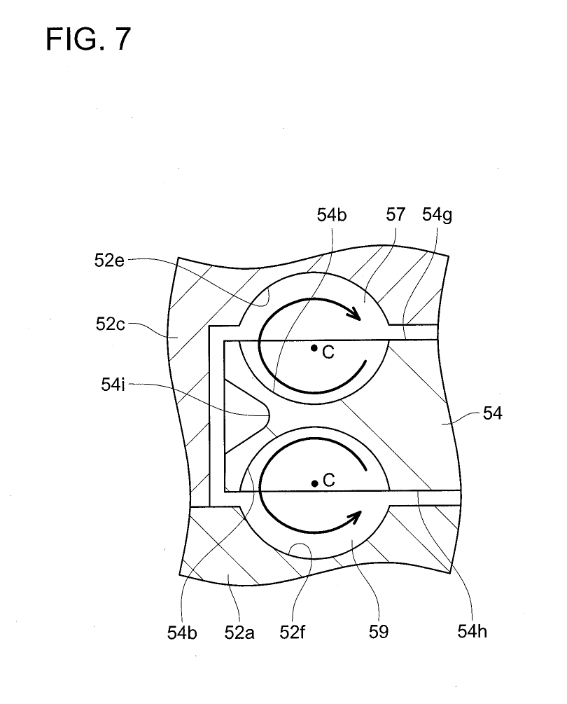

FIG. 7 is an enlarged view of a region AR of FIG. 3. Each of the plurality of blade grooves 54b arranged in the lower surface 54h of the impeller 54 opens to a lower surface 54h side of the impeller 54, while being closed on an upper surface 54g side of the impeller 54. Similarly, each of the plurality of blade grooves 54b arranged in the upper surface 54g of the impeller 54 opens to the upper surface 54g side of the impeller 54, while being closed on the lower surface 54h side of the impeller 54. That is, the plurality of blade grooves 54b arranged in the lower surface 54h of the impeller 54 and the plurality of blade grooves 54b arranged in the upper surface 54g of the impeller 54 are not communicated.

As shown in FIG. 5, a plurality of outer grooves 54i is arranged on the outer circumferential wall 54c at a center portion in the rotation axis X direction. The plurality of outer grooves 54i has a shape that is same as each other, and is arranged at an equal interval along an entire circumference of the impeller 54 along its circumferential direction (reference signs are given only to two adjacent outer grooves 54i in FIG. 5). The outer grooves 54i are recessed from an outer circumferential surface of the outer circumferential wall 54c in a radial direction of the impeller 54. As shown in FIG. 7, each outer groove 54i is deepest at its center in the rotation axis X direction of the impeller 54 (that is, with a longest length in the radial direction of the impeller 54), and becomes gradually shallower toward respective ends thereof in the rotation axis X direction. The outer grooves 54i are separated from both ends of the outer circumferential wall 54c in the rotation axis X direction. The outer grooves 54i are blocked relative to the blade grooves 54b, and are not communicating therewith. As shown in FIG. 5, one blade 54j is arranged between two adjacent outer grooves 54i, 54i.

During when the purge pump 10 is driving, the impeller 54 is rotated by the rotation of the motor unit 20. As a result, a gas containing the vaporized fuel absorbed in the canister 73 is suctioned from the suction port 56 into the lower housing 52. A vortex of the gas (swirling flow thereof) is generated in a space 57 formed by the blade grooves 54b and the opposing groove 52e. The same is applied to a space 59 formed by the blade grooves 54b and the opposing groove 52f. As a result, the gas in the lower housing 52 is pressurized, and is discharged from the discharge port 58.

As shown in FIG. 6, the gas including the vaporized fuel flown in from the suction port 56 to the lower housing 52 progresses in the rotation direction R by the rotation of the impeller 54. Due to this, a vortex is generated in the gas in each of the spaces 57, 59 formed by the blade grooves 54b of the impeller 54 and the opposing groove 52e and by the blade grooves 54b and the opposing groove 52f. As shown by arrows in FIG. 7, the vortexes pass bottom surface sides of the blade grooves 54b and flow to outer circumferential side of the impeller 54. The impeller 54 has the outer circumferential wall 54c arranged. Due to this, the gas is guided by the outer circumferential wall 54c and flows to upper and lower surfaces 54g, 54h sides of the impeller 54. Then, it flows into the opposing groove 52e and toward a center of the impeller 54 along bottom surface of the opposing groove 52e. Each vortex flows about a swirl center C. In the rotation axis X direction, an upper end of the outer circumferential wall 54c is above the swirl center C, that is, arranged on the upper surface 54g side, and a lower end of the outer circumferential wall 54c is below the swirl center C, that is, arranged on the lower surface 54h side. Due to this, each vortex is guided by the outer circumferential wall 54c and swirls smoothly.

The gas progresses in the rotation direction R while being pressurized by the vortexes. The gas that has reached the end of the discharge port 58 is discharged from the discharge port 58 to outside the lower housing 52. As a result, the high-pressure gas is discharged from the spaces 57, 59 passing the end of the discharge port 58 and pressure therein drops. Since the impeller 54 is provided with the outer circumferential wall 54c, the gas that has flown out to the discharge port 58 is blocked by the outer circumferential wall 54c, so the gas is suppressed from flowing back to the spaces 57, 59 where the pressure is relatively low. As a result, pump efficiency can be suppressed from decreasing by the backflow.

In a vortex pump for a liquid, a volume of the liquid that is to be filled in the housing does not change despite being pressurized, from which the backflow is less likely to occur. Thus, an influence of the backflow from the discharge channel does not have to be considered. On the other hand, in the purge pump 10 for a gas, the gas is filled in the lower housing 52 while the pump is driven. However, in a situation in which the high-pressure gas in the discharge port 58 flows back to the lower housing 52, if the outer circumferential wall 54c is not arranged, the gas in the lower housing 52 is compressed and the high-pressure gas can easily flow back into the housing. Due to this, by arranging the outer circumferential wall 54c, the pump efficiency can be improved.

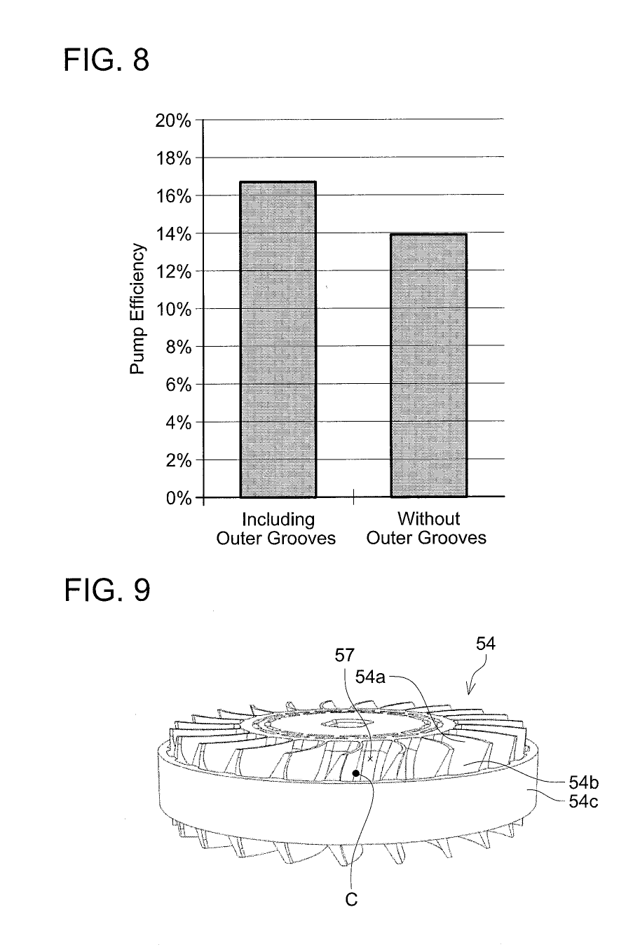

Next, a simulation result achieved from an experiment of the purge pump 10 will be shown with reference to FIG. 8. In this simulation, the pump unit 50 of the purge pump 10 was modelized, and a flow rate of the gas discharged from the discharge port 58 when the impeller 54 is rotated was calculated. A revolution speed of the impeller 54 was about 8000 rpm.

In this simulation, the simulation was carried out using the impeller 54 shown in FIGS. 4 and 5 and an impeller that does not have the outer grooves 54i as a comparative example thereof. A vertical axis of a graph in FIG. 8 indicates the pump efficiency. The pump efficiency is obtained by dividing (flow rate×pressure) of the discharged gas by (revolution speed×torque) of the impeller. In FIG. 8, the pump efficiency of the impeller 54 (that is, the impeller 54 including the outer grooves 54i) is shown on the left side, and the pump efficiency of the impeller of the comparative example (that is, the impeller without outer grooves) is shown on the right side.

As apparent from the graph in FIG. 8, the pump efficiency of the purge pump 10 having the impeller 54 including the outer grooves 54i of the embodiment is high as compared to the pump efficiency of a purge pump having the impeller without the outer grooves of the comparative example. This is because the gas is fed out from the lower housing 52 toward the discharge port 58 and the gas that had flown into the discharge port 58 is suppressed from flowing back from the discharge port 58 toward the impeller 54 side by the outer grooves 54i.

Further, since the impeller 54 has the outer circumferential wall 54c, the flow of the gas toward the outer circumferential direction of the impeller 54 in each of the spaces 57, 59 can be guided smoothly upward. Especially when seen along the rotation axis X direction, a height of the blade grooves 54b of the outer circumferential wall 54c from the bottom surfaces thereof is greater than a height of the centers C of the vortexes in the spaces 57, 59 from the bottom surfaces, and as such, the gas can be flown upward.

As in this embodiment, the purge pump 10 used for supplying the gas to the engine 8 of the vehicle simply needs to supply the gas by an amount used by the engine 8, so the discharged gas amount is not so large as compared to other industrial vortex pumps. Due to this, when the backflow amount from the discharge channel increases even by a small amount, a ratio of the backflow amount from the discharge port relative to the discharged gas amount becomes high, and the pump efficiency is thereby reduced. In the purge pump 10 of the present embodiment, the pump efficiency can be suppressed from being reduced by arranging the outer circumferential wall 54c to the impeller 54.

### Second Embodiment

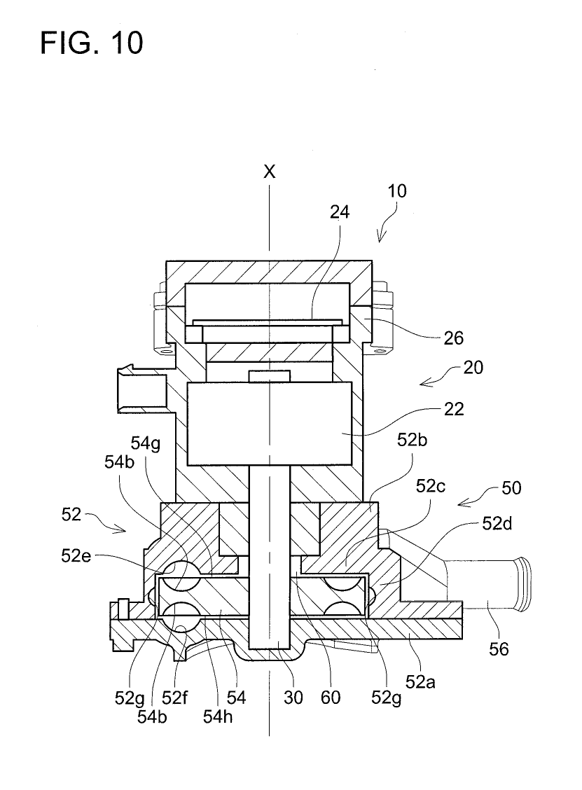

Features differing from those of the first embodiment will be described. As shown in FIG. 10, in the purge pump 10 of the present embodiment, the impeller 54 is not provided with the outer grooves 54i. The outer circumferential surface of the outer circumferential wall 54c of the impeller 54 has a cylindrical shape.

Further, the housing 52 is provided with a recess portion 52g in an inner circumferential surface 52m of the circumferential wall 52d opposing the outer circumferential wall 54c. The recess portion 52g has a groove shape that is arranged over an entire length in the circumferential direction of the impeller 54. The recess portion 52g is formed so as to recess the circumferential wall 52d toward a direction separating away from the impeller 54, that is, in a direction separating perpendicularly away from the rotation axis X. A cross section of the recess portion 52g has a semicircular shape.

According to this configuration, the gas between the outer circumferential wall 54c of the impeller 54 and the circumferential wall 52d of the housing 52 can be pressurized by the recess portion 52g while the purge pump 10 is driven. Due to this, the gas pressurized by the blade grooves 54b of the impeller 54 can be suppressed from flowing out between the outer circumferential wall 54c of the impeller 54 and the circumferential wall 52d of the housing 52. As a result, a situation in which the pressurization by the blade grooves 54b is hindered can be avoided. Due to this, the gas mount discharged from the pump 10 can be suppressed from being reduced.

### Third Embodiment

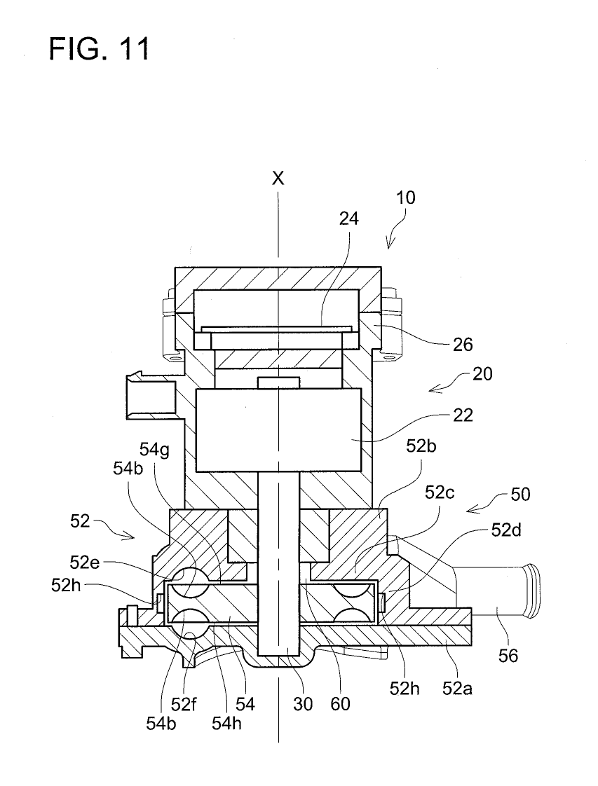

Features differing from those of the second embodiment will be described. As shown in FIG. 11, the housing 52 is provided with a recess portion 52h in the inner circumferential surface 52m of the circumferential wall 52d. A cross section of the recess portion 52h is rectangular. Other configurations are same as those of the second embodiment.

### Fourth Embodiment

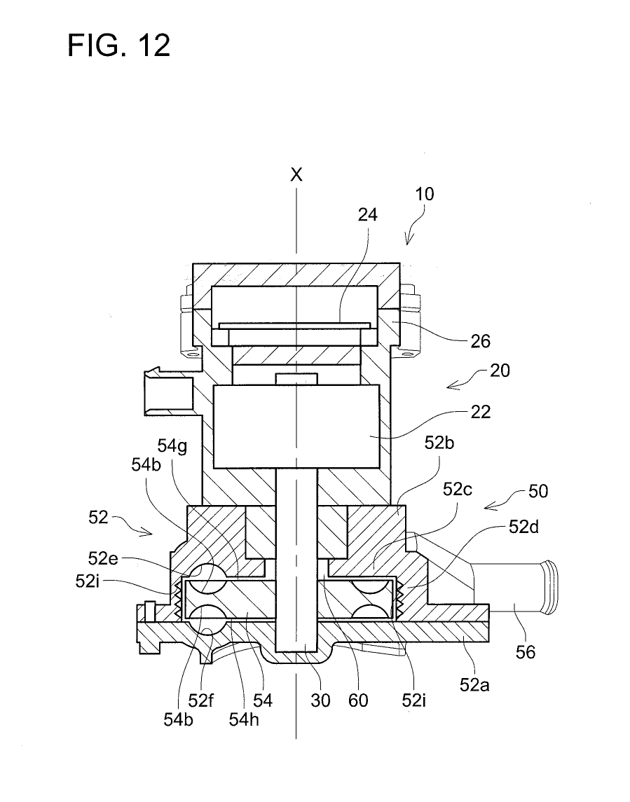

Features differing from those of the second embodiment will be described. As shown in FIG. 12, the housing 52 is provided with a recess portion 52i in the inner circumferential surface 52m of the circumferential wall 52d. A cross section of the recess portion 52i is in a shape with plural triangular shapes being arranged in the rotation axis X direction. Other configurations are same as those of the second embodiment.

In the second to fourth embodiments, the recess portions 52g, 52h, 52i have the groove shape arranged over the entire length in the circumferential direction of the impeller 54. However, the recess portions 52g, 52h, 52i may each be arranged only partially in the circumferential direction of the impeller 54, or may be arranged intermittently along the circumferential direction of the impeller 54. In the configurations in which the plurality of recess portions is arranged in the circumferential direction of the impeller 54, the cross sections of the plurality of recess portions may be identical or different. Further, positions of the plurality of recess portions in the rotation axis X direction may be identical or different.

Further, the cross-sectional shapes of the recess portions 52g, 52h, 52i are not limited to the shapes exemplified in the second to fourth embodiments, and may be polygonal or U-shaped.

### Fifth Embodiment

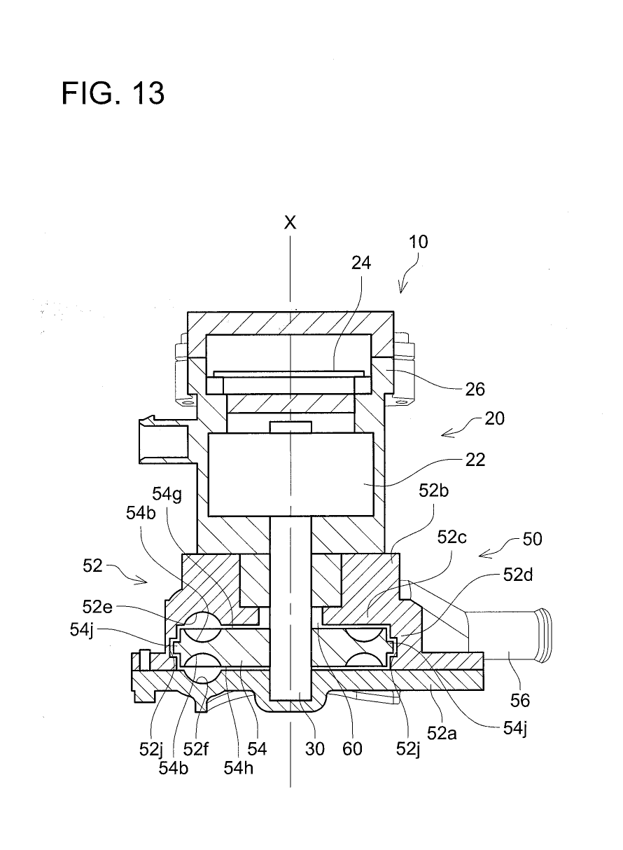

Features differing from those of the second embodiment will be described. As shown in FIG. 13, the housing 52 is provided with a recess portion 52j in the inner circumferential surface 52m of the circumferential wall 52d. The recess portion 52j has a same shape as that of the recess portion 52h of the third embodiment.

The impeller 54 includes a projected portion 54j that projects in the radial direction of the impeller 54 from the outer circumferential wall 54c. The projected portion 54j projects from the outer circumferential wall 54c toward an inside of the recess portion 52j. A part of the projected portion 54j is arranged within the recess portion 52h. The projected portion 54j is arranged over an entire length in the circumferential direction of the impeller 54. A cross section of the projected portion 54j has a shape that accords with a shape of the recess portion 52j.

According to this configuration, a clearance between the outer circumferential wall 54c of the impeller 54 and the circumferential wall 52d of the housing 52 can complicate the passage of the gas flowing in the rotation axis X direction. Due to this, the gas can be suppressed from flowing out between the outer circumferential wall 54c of the impeller 54 and the circumferential wall 52d of the housing 52.

The shape of the projected portion 54j may not be a shape that accords with the shape of the recess portion 52j. For example, the cross-sectional shape of the projected portion 54j may be triangular, or may be semicircular.

### Sixth Embodiment

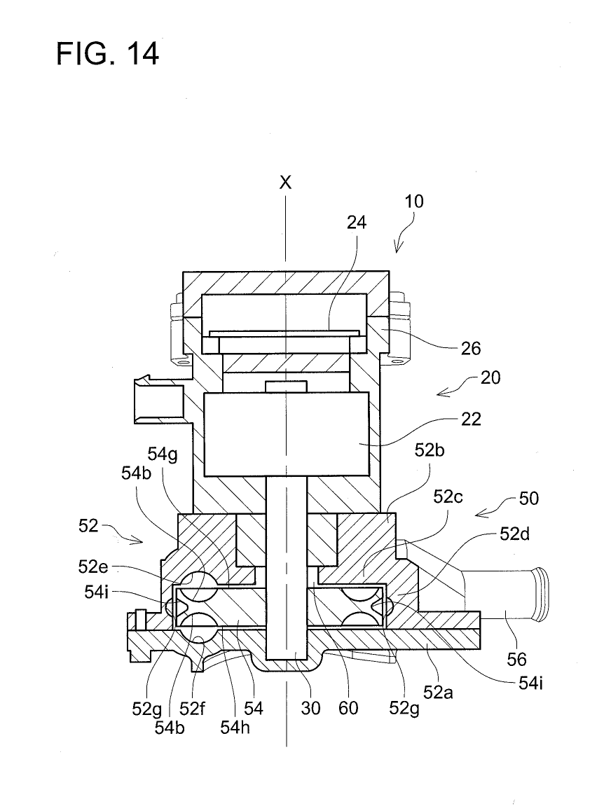

Features differing from those of the second embodiment will be described. As shown in FIG. 14, in the purge pump 10 of the present embodiment, the impeller 54 has the outer grooves 54i similar to the first embodiment. The outer grooves 54i and the recess portion 52g face each other. According to this configuration, since the gas is pressurized between the outer grooves 54i and the recess portion 52g while the purge pump 10 is driving, the gas pressurized by the blade grooves 54b can be suppressed from flowing out between the outer circumferential wall 54c of the impeller 54 and the circumferential wall 52d of the housing 52.

### Seventh Embodiment

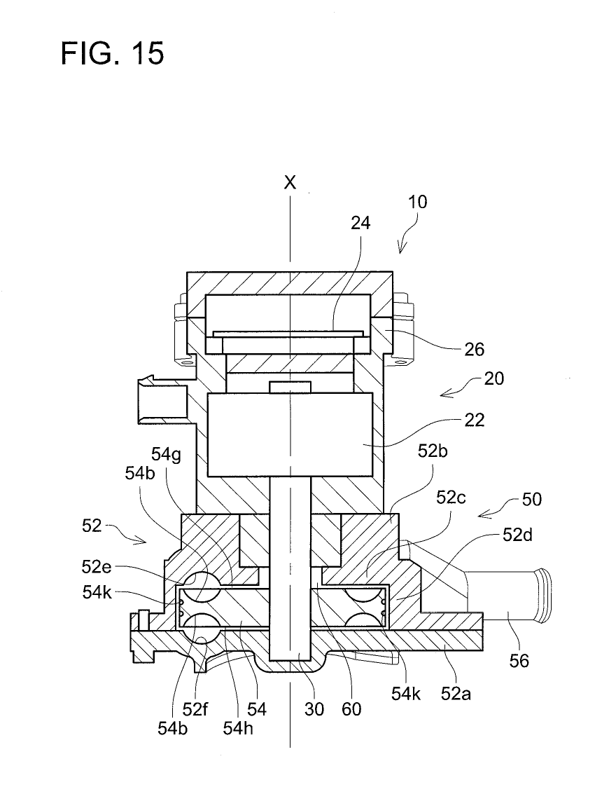

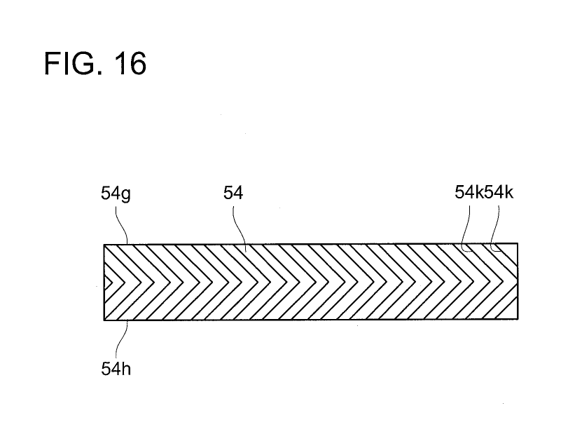

Features differing from those of the first embodiment will be described. As shown in FIGS. 15 and 16, the impeller 54 is provided with a plurality of outer grooves 54k on the outer circumferential wall 54c instead of the outer grooves 54i. The plurality of outer grooves 54k is arranged in the circumferential direction of the impeller 54 with an interval in between them. Each of the outer grooves 54k is inclined in the rotation direction R of the impeller 54 along the rotation axis X from its end on the upper surface 54g side toward the lower surface 54h. Further, each of the outer grooves 54k is bent at its center in the rotation axis X direction, and is inclined in an opposite direction to the rotation direction R of the impeller 54 from a bent position toward the lower surface 54h.

According to this configuration, the gas between the outer circumferential wall 54c of the impeller 54 and the circumferential wall 52d of the housing 52 can be flown in either direction toward the upper surface 54g or toward the lower surface 54h along the outer grooves 54k during when the purge pump 10 is driving. Due to this, the gas pressurized by the blade grooves 54b can be suppressed from flowing out between the outer circumferential wall 54c of the impeller 54 and the circumferential wall 52d of the housing 52.

The shape of the outer grooves 54k is not limited to the shape in the seventh embodiment, and may for example be curved at their centers in the rotation axis X direction. Further, the bent position or a curved position of each outer groove 54k may be displaced upward or downward from the center in the rotation axis X direction.

### Eighth Embodiment

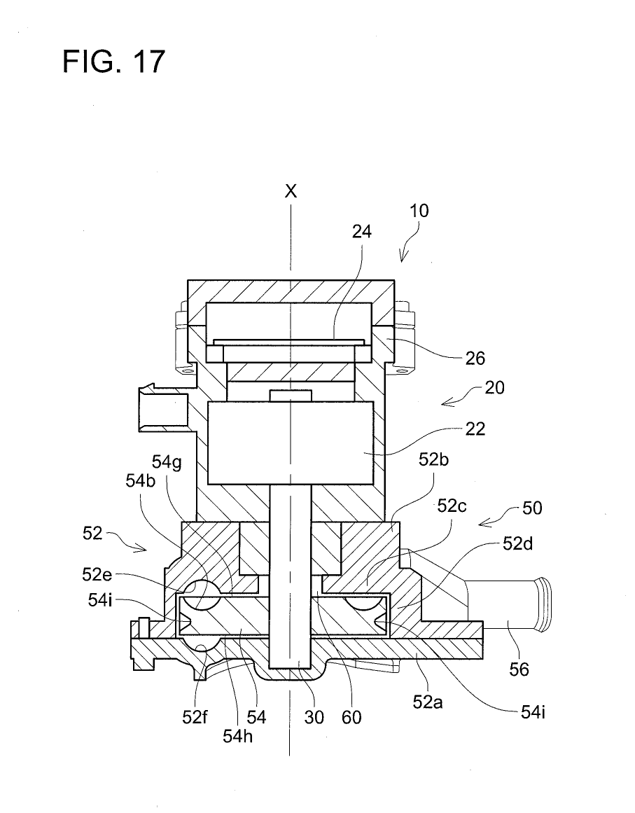

Features differing from those of the first embodiment will be described. As shown in FIG. 17, the impeller 54 is provided with the blade groove region 54f including the plurality of blades 54a and the plurality of blade grooves 54b at its upper surface 54g, similar to the first embodiment. On the other hand, the lower surface 54h of the impeller 54 is not provided with the blade groove region 54f. The outer circumferential portion of the lower surface 54h of the impeller 54 has a planar shape continuous with other portions of the lower surface 54h of the impeller 54.

In the outer circumferential wall 54c of the impeller 54, the outer grooves 54i are arranged lower than a center portion of the outer circumferential wall 54c in the rotation axis X direction.

According to this configuration, the gas is pressurized by the blade groove region 54f of the upper surface 54g of the impeller 54. Due to this, a pressure difference can be made relatively large between the upper surface 54g and the lower surface 54h of the impeller 54. In a variant, the impeller 54 may be provided with the blade groove region 54f including the plurality of blades 54a and the plurality of blade grooves 54b at its lower surface 54h, and may not be provided with the blade groove region 54f at its upper surface 54g.

The embodiments of the present invention have been described above in detail, however, these are mere examples and thus do not limit the scope of the claims. The techniques recited in the claims encompass configurations that modify and alter the above-exemplified specific examples.

For example, the shape of the outer circumferential wall 54c of the impeller 54 is not limited to the shapes in the respective embodiments as above. For example, as shown in FIG. 9, in the the outer circumferential wall 54c, the upper end of the outer circumferential wall 54c may have an equaling height as the center C of the vortex in the space 57. The same is applied to the lower end of the outer circumferential wall 54c. According to such configurations as well, the flow of the gas toward the outer circumferential direction of the impeller 54 in the spaces 57, 59 can smoothly be guided in the swirling direction.

Further, in the first to seventh embodiments as above, the blades 54a and the blade grooves 54b of the impeller 54 have same shapes in the upper and lower surfaces 54g, 54h. However, the shapes of the blades 54a and the blade grooves 54b may be different between the upper and lower surfaces 54g, 54h. Further, the blades 54a and the blade grooves 54b of the impeller 54 may be arranged only on one of the upper and lower surfaces 54g, 54h.

Further, in each of the above embodiments, the suction port 56 and the discharge port 58 of the pump unit 50 extend in the direction perpendicular to the rotation axis X of the impeller 54. However, the suction port 56 and the discharge port 58 of the pump unit 50 may extend parallel to the rotation axis X.

Further, the shape of the outer grooves 54i is not limited to the shapes shown in the first embodiment shown in FIG. 5, the sixth embodiment shown in FIG. 14, and the eighth embodiment shown in FIG. 17. For example, the cross section of the impeller 54 in the radial direction may have an arc shape, or a polygonal shape. The outer grooves 54i simply need to be recessed in the radial direction of the impeller 54.

The “vortex pump” in the disclosure herein is not limited to the purge pump 10, and may be used in other systems as well. For example, the “vortex pump” may be a pump for supplying exhaust gas to the suction pipe 80 in an exhaust gas recirculation (that is, EGR (abbreviation of Exhaust Gas Recirculation)) system which circulates the exhaust gas from the engine 8 to be mixed with suctioned air and supplies the mixture to a fuel chamber of the engine 8. Alternatively, the “vortex pump” may be a pump for feeding a blowby gas out to the suction pipe 80 in a PCV (abbreviation of Positive Crankcase Ventilation) system for reducing the blowby gas in the engine 8 to the suction pipe 80 side. Moreover, the “vortex pump” may be a pump in a brake booster that uses a negative pressure in the suction pipe 80, and it may be arranged between the suction pipe 80 and the brake boaster for suctioning the gas in the brake booster to discharge it to the suction pipe 80.

Further, the technical features described herein and the drawings may technically be useful alone or in various combinations, and are not limited to the combinations as originally claimed. Further, the art described in the description and the drawings may concurrently achieve a plurality of aims, and technical significance thereof resides in achieving any one of such aims.

1. A vortex pump configured to discharge gas suctioned into the vortex pump to an engine of a vehicle, the vortex pump comprising:
an impeller; and
a housing rotatably housing the impeller, the housing comprising a discharge channel extending from an outer circumferential edge of the impeller along a direction separating away from a rotation axis of the impeller, wherein
the impeller comprises:
a plurality of blades disposed in an outer circumferential portion of an end surface of the impeller along a rotation direction of the impeller;
a plurality of blade grooves, each of the plurality of blade grooves being disposed between adjacent blades; and
an outer circumferential wall disposed at the outer circumferential edge, the outer circumferential wall closing the plurality of blade grooves at an outer circumferential side of the impeller, and
the housing comprises an opposing groove opposing the plurality of the blade grooves and extending along the rotation direction of the impeller.

2. The vortex pump as in claim 1, wherein
the outer circumferential wall comprises a plurality of outer grooves arranged along a circumferential direction of the impeller, the plurality of outer grooves being recessed toward a radial direction of the impeller.

3. The vortex pump as in claim 1, wherein
an end of the outer circumferential wall in an impeller rotation axis direction is located at a specific position in the impeller rotation axis direction or closer to an end surface side of the impeller than the specific position in the impeller rotation axis direction, and
the specific position is a center of a vortex generated by the respective blade grooves and the opposing groove while the impeller rotates.

4. The vortex pump as in claim 1, wherein
the housing comprises an opposing wall opposing the outer circumferential wall along a circumferential direction of the impeller, and
the opposing wall comprises a recess portion recessed toward a direction separating away from the impeller.

5. The vortex pump as in claim 4, wherein
the recess portion extends along the circumferential direction of the impeller.

6. The vortex pump as in claim 5, wherein
the recess portion surrounds an outer circumference of the impeller along the circumferential direction of the impeller, and
the outer circumferential wall comprises a projected portion disposed inside of the recess portion.
